(19) United States
(12) Patent Application Publication
(10) Pub. No.: US 2017/0356799 A1
(43) Pub. Date: Dec. 14, 2017

(54) IMAGING ASSEMBLY FOR A DRONE AND SYSTEM COMPRISING SUCH AN ASSEMBLY MOUNTED ON A DRONE

(71) Applicant: PARROT DRONES, Paris (FR)

(72) Inventors: Antoine BEYELER, Lausanne (CH); Eng Hong SRON, PARIS (FR)

(21) Appl. No.: 15/620,323

(22) Filed: Jun. 12, 2017

(30) Foreign Application Priority Data
Jun. 13, 2016 (FR) 16 55459

(51) Int. Cl. G01J 3/02; B64C 39/02; B64D 47/08

(52) U.S. Cl. CPC G01J 3/0229; B64D 47/08; B64C 39/024; G01J 3/0205; B64C 2201/021; B64C 2201/123; B64C 2201/127

(57) ABSTRACT

The imaging assembly includes:
a multi-band sensor (5), comprising a plurality of light sensors (7) each for measuring a light intensity returned by a target (8) in a predetermined frequency band;
a sunlight detector (9), comprising a plurality of control sensors (11) each for measuring an ambient light intensity in one of the predetermined bands of frequencies of the multi-band sensor (5) each associated with a band-pass filtre;
an electronic module (13) configured so as to calculate at least one characteristic variable value of the light intensity returned by the target (8) in each predetermined frequency band;
   the sunlight detector (9) comprising a box casing (21), the control sensors (11) being attached to the box casing (21), the band-pass filtres (17) being attached to the box casing (21) each one so as to be facing the photosensitive surface of the associated control sensor.

The invention relates in general to onboard imaging assemblies mounted on drones, in particular for agricultural purposes.

More precisely, according to a first aspect the invention relates to an imaging assembly designed to be mounted on board a drone.

The document US 2014/0022381 describes an imaging assembly with a multi-band sensor intended to be used for measuring the light intensity in a plurality of predetermined bands of frequencies, and a sunlight detector intended to be used for measuring the level of ambient light intensity in the same predetermined bands of frequencies.

The sunlight detector includes a camera apparatus for taking images with a photosensitive matrix display screen, integrated into the multi-band sensor. The sunlight detector additionally also includes a plurality of optical fibres and band-pass fibres. Each band-pass fibre is associated with the end of an optical fibre and filters the light radiation picked up/captured by the optical fibre. The optical fibre directs the light captured to a zone of the photosensitive matrix display screen.

Such an assembly is complex and fragile. In particular, the radius of curvature of the optical fibres must be controlled and known.

In this context, the invention aims to provide an assembly that is simpler and more reliable.

To this end, the invention relates to an imaging assembly for a drone, the assembly including:

a multi-band sensor, comprising a plurality of light sensors each for measuring a light intensity returned by a target in a predetermined frequency band, the bands of frequencies associated with the various different light sensors being different from each other;

a sunlight detector, comprising a plurality of control sensors each for measuring an ambient light intensity in one of the predetermined bands of frequencies of the multi-band sensor, with the sunlight detector including for each control sensor a band-pass filtre configured so as to ensure that an incident ray of light within the associated frequency band arrives at a photosensitive surface of the said control sensor and that an incident ray of light outside the associated frequency band does not arrive at a photosensitive surface of the said control sensor;

an electronic module configured so as to calculate at least one characteristic variable value of the light intensity returned by the target in each predetermined frequency band, by using the light intensities returned by the target in the said predetermined bands of frequencies measured by the multi-band sensor and the ambient light intensities in the said predetermined bands of frequencies measured by the sunlight detector; the sunlight detector comprising a box casing, the control sensors being attached to the box casing, the band-pass filtres being attached to the box casing each one so as to be facing the photosensitive surface of the associated control sensor.

The assembly may also present one or more of the characteristic features following here below, considered individually or in accordance with all technically possible combinations:

the multi-band sensor includes another box casing that is independent and separate from the box casing of the sunlight detector, the light sensors being attached to the said other box casing;

the sunlight detector includes a light diffuser, attached to the box casing so as to be facing the band-pass filtres, in a manner such that the incident light rays pass through the light diffuser before reaching the band-pass filtres;

the sunlight detector includes, for each control sensor, a convergent lens disposed so as to be facing the corresponding band-pass filtre and interposed between the light diffuser and the said band-pass filtre;

the sunlight detector includes a single convergent lens disposed so as to be facing all of the band-pass filtres and interposed between the light diffuser and the said band-pass filtres;

the sunlight detector includes, for each control sensor, a screen disposed so as to be facing the associated band-pass filtre and interposed between the light diffuser and the said band-pass filtre, the screen having a conical aperture converging from the diffuser towards the said band-pass filtre; and

the sunlight detector comprises a plate and a support attached on to the plate and delimiting a plurality of wells, the control sensors being mounted on to the plate each at the bottom of one of the wells, the band-pass filtres being mounted in the wells above the control sensors.

According to a second aspect, the invention relates to a system that includes a flying drone and an imaging assembly having the characteristic features described here above, mounted on the drone.

In addition, the system may present the following characteristic features:

the drone comprises a body having top and bottom surfaces provided so as to be turned upwards and downwards respectively when the drone is in hovering flight, the multi-band sensor being attached to the bottom surface and the sunlight detector being attached to the top surface.

According to a third aspect, the invention relates to a calculation method for calculation of at least one characteristic variable value of the light intensity returned by a target in a plurality of predetermined bands of frequencies, the method including the following steps:

flying over the target by making use of a system that includes a flying drone and an imaging assembly;

during the over-flight, measuring by the imaging assembly, at a plurality of successive time instants, of the light intensity returned by the target in each of the said predetermined bands of frequencies;

during the over-flight, measuring by the imaging assembly, at a plurality of successive time instants, of the ambient light intensity in each of the said predetermined bands of frequencies, and simultaneously, recording of a parameter characterising the orientation of the sunlight detector in relation to the sun;

calculation of the characteristic variable value of the light intensity that is returned by the target in each predetermined frequency band by using the light intensities returned by the target in the said previously measured predetermined bands of frequencies and the ambient light intensities in the said previously measured predetermined bands of frequencies;

the step of calculation includes:

a determination sub-step for determining the orientation of the target in relation to the sun;

a calculation sub-step for calculating the total light intensity received by the target in one of the frequency bands, using only the ambient light intensities in the said frequency band that are measured when a difference between the orientation of the sunlight detector in relation to the sun and the orientation of the target in relation to the sun is less than a predetermined value.

Other characteristic features and advantages of the invention will emerge from the detailed description that is provided here below, by way of indicative example and without limitation, with reference made to the attached figures, among which:

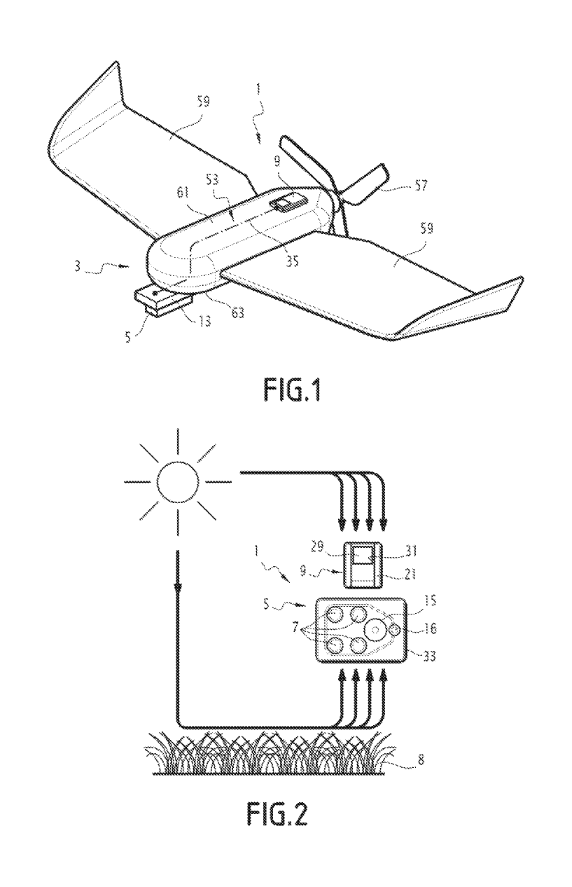

FIG. 1 is a simplified schematic representation of a drone in flight equipped with an imaging assembly according to the invention;

FIG. 2 is a schematic representation illustrating the operation of the imaging assembly shown in FIG. 1;

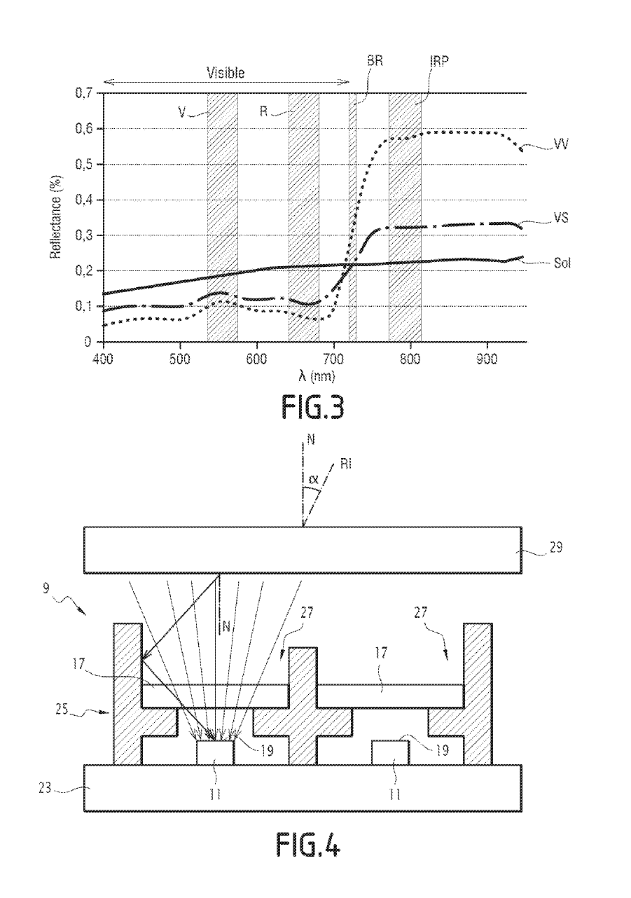

FIG. 3 is a graph indicating the levels of reflectance of a type of agricultural crop determined as a function of the wavelength of the light, and the bands of frequencies measured by the imaging assembly shown in FIG. 1.

FIGS. 4 to 7 illustrate different embodiments of the sunlight detector of the imaging assembly shown in FIG. 1; and

FIG. 8 schematically illustrates different angles considered in the method of the invention.

As can be seen in FIG. 1, the imaging assembly 1 is designed to be mounted on board a drone, and more precisely on a flying drone 3. It is intended to be used in the field of agriculture, typically in order to monitor the growth of crops.

As is visible in FIGS. 1 and 2, the assembly 1 includes:
a multi-band sensor 5, comprising a plurality of light sensors 7 each for measuring the light intensity returned by a target 8 in a predetermined frequency band;
a sunlight detector 9, comprising a plurality of control sensors 11 (FIGS. 4 to 7) each for measuring an ambient light intensity in one of the predetermined bands of frequencies of the multi-band sensor 5;
an electronic module 13, configured so as to calculate at least a characteristic variable value of the light intensity returned by the target 8 in each predetermined frequency band, by using the light intensities returned by the target 8 in the said predetermined bands of frequencies measured by the multi-band sensor 5, and the ambient light intensities in the said predetermined bands of frequencies measured by the sunlight detector 9.

The target 8, for applications in the field of agriculture, typically corresponds to a crop, for example a field of corn, wheat or any other type of crop. The multi-band sensor 5 measures the intensity of the light reflected by the crops in the predetermined bands of frequencies.

The frequency bands associated with the various different light sensors 7 are different from each other. They are chosen based on the application being considered.

In a typical example, the multi-band sensor 5 includes four light sensors 7, provided as illustrated in FIG. 3 in order to measure the light intensity in a frequency band V corresponding to the colour green in the visible spectrum, in a frequency band R corresponding to the colour red in the visible spectrum, in a frequency band BR situated in the infrared frequency domain in immediate proximity to the visible spectrum, and a frequency band IRP corresponding to the near infrared.

For example, the band V is centred on a wavelength of 550 nanometres and has a width of 40 nanometres, the band R is centred on a wavelength of 660 nanometres and has a width of 40 nanometres, the band BR is centred on a wavelength of 735 nanometres and has a width of 10 nanometres, and the band IRP is centred on a wavelength of 790 nanometres and has a width of 40 nanometres.

The reflectance of plants, that is to say, the percentage of incident light intensity reflected by the plant for each wavelength, varies as a function of the state of the plant. In FIG. 3, the curve VV represents the reflectance of a healthy plant, as a function of the wavelength. The curve VS represents the reflectance of a plant that is stressed as a function of the wavelength. The curve S shows the reflectance of the ground as a function of the wavelength.

It is seen that, indeed both for the curve VV as well as for the curve VS, the reflectance in the visible spectrum is maximum for the frequency band V.

The difference in reflectance between healthy plants and stressed plants is more significant in the frequency band R than in the frequency band V. The band BR corresponds to a region of the spectrum where the reflectance increases abruptly, both for healthy plants as well as for stressed plants.

In the near infrared domain, that is to say for the band IRP, one notes a very significant difference in reflectance between the healthy plants and the stressed plants.

Thus, it is indeed understood that the data relating to light intensity returned by the target, which is a crop with respect to the agricultural domain, for the various predetermined bands of frequencies, provide information on the state of the crop. These data show in particular whether or not the crop is under stress.

This stress may be a water (hydric) stress, the plant not being provided with sufficient water (undernourished). The stress can also be due to an attack by a microorganism, a parasite or the like.

The light intensity measured by the multi-band sensor 5 is a function of the ambient sunlight. The sunlight sensor 9 is thus provided in order to make it possible to correct the light intensity values measured by the multi-band sensor 5, as a function of the ambient light intensity.

This correction is performed by the electronic module 13.

The electronic module 13 is for example integrated into the multi-band sensor 5. By way of a variant, it can be mounted on board the drone, or indeed even be situated in a remote information processing unit. The module 13, for example, is a computing unit or an assembly of programmable logic components, or even an assembly of dedicated integrated circuits.

For example, the light intensity returned by the target 8 in a predetermined frequency band measured by the multi-band sensor 5 is corrected proportionally to the ambient light intensity in the same predetermined frequency band measured by the sunlight detector 9.

By way of a variant, the correction effected is calculated in a different fashion. These corrections are of known types and have not been detailed here.

The characteristic variable value calculated by the electronic module 13 is for example the light intensity returned by the target 8 in the predetermined frequency band corrected as a function of the measurements of the sunlight detector 9, or corresponds to the reflectance of the target 8 in the predetermined frequency band, or is any other pertinent variable value.

Typically, the multi-band sensor 5 includes, in addition to the light sensors 7, an RGB camera 15, that provides the ability to capture images in the visible spectrum of the target 8, typically crops.

The multi-band sensor 5 typically includes a remote communication module 16 for communicating remotely by waves, for example of wifi type.

Each light sensor 7 is typically an imaging apparatus for capturing images, such as a photographic camera having a resolution of 1.2 megapixels for example.

The multi-band sensor 5 typically includes for each light sensor 7 a band-pass filtre that is not represented, configured in order to filter the incident light rays and to let pass only those which are in the frequency band associated with the light sensor 7.

The control sensors 11 of the sunlight detector 9 are for example photodiodes. Such diodes transform light radiation into electric signals.

The control sensors 11 are provided for each measuring the ambient light intensity in one of the predetermined bands of frequencies of the multi-band sensor 5, as indicated here above. The control sensors 11 measure the ambient light intensity in frequency bands that are different from each other. Thus, there is the same number of control sensors 11 as light sensors 7.

In order to filter the incident rays of light, the sunlight detector 9 includes for each control sensor 11 a band-pass filtre 17 (FIGS. 4 to 7), configured so as to ensure that an incident ray of light in the frequency band associated with the control sensor 11 can arrive at the photosensitive surface 19 of the control sensor, and that an incident ray of light outside the associated frequency band does not arrive at a photosensitive surface 19 of the control sensor 11.

As may be seen in FIGS. 2 and 4, the sunlight detector 9 includes a box casing 21, the control sensors 11 and the band-pass filtres 17 being attached to the said box casing. It can be seen in FIG. 4 that the band-pass filtres 17 are attached so as to each be facing the photosensitive surface 19 of the associated control sensor 11.

More precisely, the sunlight detector 9 comprises a plate 23 and a support 25 attached on to the plate 23. The plate 23 and the support 25 are typically attached to the interior of the box casing 21.

The control sensors 11 are mounted on to the plate 23. The plate is typically a printed circuit (or PCB for: “Printed Circuit Board”).

The support 25 delimits a plurality of wells 27, the control sensors 11 being each disposed at the bottom of a well. The wells 27 are closed at one end by the plate 23 and are open at the opposite end.

For a sunlight detector 9 comprising four control sensors 11, the wells are disposed for example on the corners of a square.

The band-pass filtres 17 are mounted in the wells 27, above the control sensors 11.

More precisely, each filtre 17 is mounted in a manner such that the photosensitive surface 19 of the associated control sensor 11 is directly facing the band-pass filtre 17 along the central axis of the well 27.

In the embodiment shown in FIG. 4, the sunlight detector 9 includes a light diffuser 29, attached to the box casing 21 so as to be facing the band-pass filtres 17. Thus, the incident light rays pass through the light diffuser 29 before reaching the band-pass filtres.

The light diffuser 29 for example is substantially parallel to the band-pass filtres 17 and situated slightly at a distance, over the band-pass filtres 17. It is situated above the support 25. Typically, it is attached in a window 31 formed on the box casing 21 (FIG. 2), so as to be facing the support 25.

The diffuser 29 makes it possible to obtain an excellent correction of the light intensity measured by the multi-band sensor 5. Indeed, the control sensors 11 should be representative of the functioning of a plant. It is known that a plant incorporates light energy in different ways based on the angle of incidence of the light rays. The rays that skim the surface of the plant are not absorbed by the latter. The diffuser 29 is configured in a manner such that the incident light rays RI that with the normal N at the diffuser form an angle of incidence α close to 90° are reflected almost in their totality.

The incident light rays that with the normal N form an angle of incidence α that is smaller, are reflected by the diffuser 29 in a much smaller proportion.

The diffuser 29 is a plate made of a material chosen in a manner so as to diffuse practically all of the incident light flux, without absorption. A part of the incident light flux is reflected, and another part is transmitted through the diffuser 29. The transmitted light flux presents a luminance that is substantially identical in all directions, regardless of the orientation of the light flux. The diffuser is substantially flat, in order to get a cosine response as a function of the incident angle.

The diffuser 29 is for example made from Makrolon 2407 020080.

As is shown in FIG. 1 and FIG. 2, the multi-band sensor 5 includes another box casing 33 that is independent and separate from the box casing 21 of the sunlight detector.

The light sensors 7 are mounted on to the said other box casing 33.

The box casings 21 and 33 may thus be mounted in an independent manner on the drone 3. They are not connected to each other by an optical fibre. They communicate with each other by waves, or by means of a cable 35 that makes it possible to transfer the data measured by the sunlight detector 9 to the multi-band sensor 5.

These data are directly exploited by the electronic module 13. If the electronic module 13 is remotely placed at a distance, the data measured by the multi-band sensor 9 are for example transferred to the electronic module 13 by the remote communication module 16 with which the multi-band sensor 5 is fitted.

Thus in the invention, the sunlight detector constitutes a stand-alone autonomous unit, which is independent of the multi-band sensor. It is not necessary to use fibre optics in order to bring the light to a photosensitive member integrated into the multi-band sensor.

A second embodiment of the invention will now be described, with reference made to FIG. 5. Only the points whereby the second embodiment differs from the first will be described here below. The elements that are identical or that ensure the same functions shall be designated by the same reference identifiers in the two embodiments.

In the embodiment shown in FIG. 5, the sunlight sensor 5 includes, for each control sensor 11, a convergent lens 35 disposed so as to be facing the corresponding band-pass filtre 17. The lens 35 is interposed between the light diffuser 29 and the band-pass filtre 17.

Typically, the convergent lens 35 is disposed at the inlet of the well 27 in which the band-pass filtre 17 is disposed.

It is attached to the support 25. It is mounted for example with a convex surface 37 turned towards the diffuser 29 and a planar surface 39 turned towards the band-pass filtre 17.

The use of lenses makes it possible to enhance the reliability of the measurement of the ambient light intensity in the predetermined bands of frequencies.

Indeed, the diffuser 29 has an angular response, in the sense where for an incident light ray having a given angle of incidence at the level of the diffuser 29, the transmitted ray will leave the diffuser 29 forming an angle with the normal N which is a function of the wavelength of the incident ray. The diffuser 29 behaves like a diffuse source at output, that is to say towards the control sensors 11.

Moreover the band-pass filtres used are interferometric type filtres. They have the advantage of having very steep cut-off slopes. However, because of the presence of the diffuser, these band-pass filtres let pass a part of the energy in the infrared range, and have a pass band shifted to the blue.

This phenomenon is particularly marked for a band-pass filtre 17 centred on the colour green of the visible spectrum.

The addition of a convergent lens 35 makes it possible to correct this phenomenon.

In effect, the light rays transmitted through the diffuser 29 are effectively parallelised by the convergent lens 35, similar to the optical system of a photographic camera apparatus.

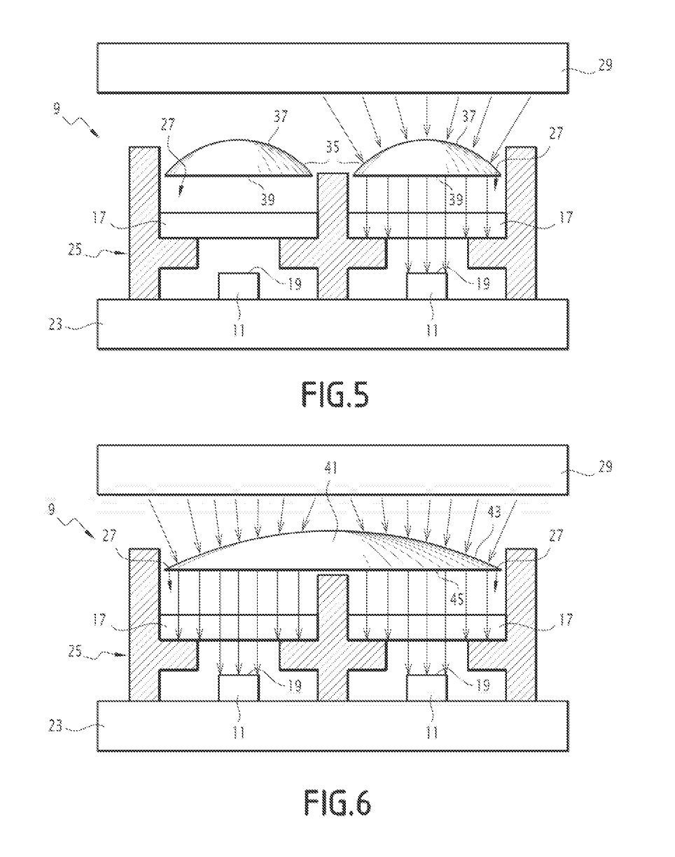

A third embodiment will now be described, with reference made to the FIG. 6. Only the points whereby the third embodiment differs from the second embodiment will be detailed here below. The elements that are identical or that ensure the same functions shall be designated by the same reference identifiers in the two embodiments.

The embodiment shown in FIG. 6 is designed to solve the same problems as that in FIG. 5, that is to say the bias introduced by the diffuser 29 for the measurements of ambient light intensity.

In the embodiment shown in FIG. 6, the convergent lenses 35 each dedicated to a control sensor 11 are replaced by a single convergent lens 41, disposed so as to be facing all the band-pass filtres 17, and interposed between the diffuser 29 and the band-pass filtres 17.

The single convergent lens 41 covers the four wells 27. It is attached to the support 25. For example, it has a convex surface 43 turned towards the diffuser 29 and a planar surface 45 turned towards the band-pass filtres 17.

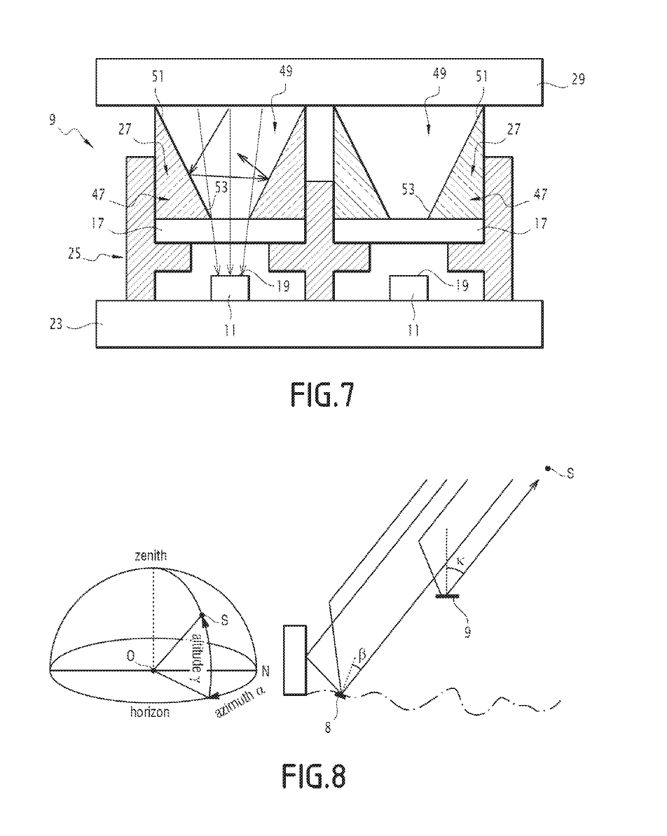

A fourth embodiment of the invention will now be described with reference made to FIG. 7. Only the points whereby this fourth embodiment differs from the second embodiment will be detailed here below. The elements that are identical or that ensure the same functions shall be designated by the same reference identifiers in the two embodiments.

The fourth embodiment is aimed at overcoming the same problems as the second embodiment, that is to say the bias introduced by the diffuser in the measurements of the sunlight sensor.

As can be seen in FIG. 7, each convex lens 35 is replaced by a screen 47 disposed so as to be facing the band-pass filtre 17 and interposed between the light diffuser 29 and the said band-pass filtre 17. The screen 47 is opaque. Formed therethrough is a conical orifice 49, converging from the diffuser 29 towards the band-pass filtre 17.

The conical orifice 49 has an axis that is substantially perpendicular to the diffuser 29. The wider end of the conical orifice 49 is pressed up against the diffuser 29. The narrowed end 53 of the conical orifice 49 is pressed up against the band-pass filtre 17. It is located along the central axis of the cone, so as to be directly facing the photosensitive surface of the control sensor 19.

Thus, as shown in FIG. 7, only the rays of light leaving the diffuser 29 along a direction that is practically normal to the said diffuser 29 reach the band-pass filtre 17 and eventually the detector 11. The rays of light leaving the diffuser 29 along a direction that deviates away from the normal are reflected by the surface of the conical orifice and returned. They do not reach the band-pass filtre 17.

The angle of opening of the cone is chosen based on the effect desired.

For example, all the light rays that exit out of the diffuser 29 with an angle that is greater than a predetermined value as compared to the normal are returned, with this value being for example of the order of 12°.

The deficiencies described previously, namely the shifting to the blue of the pass band and letting pass a part of the energy in the infrared, are eliminated.

Advantageously, the imaging assembly 1 is equipped with an orientation sensor for determining orientation, for example from an inertial centre, that makes it possible to determine on an ongoing basis the orientation of the detector 9 in relation to a reference direction, the magnetic north for example.

In this case, the electronic module 13 is preferably configured in order to implement the calculation method which will be described below.

As can be seen in FIG. 1, the drone 3 includes for example a body 55, a blade propeller 57 at the rear of the body, 55, and two wings 59. By way of a variant, the drone is a quadricopter.

Typically, the multi-band sensor 5 and sunlight detector 9 are mounted on to the drone in a manner such that the multi-band sensor 5 is turned facing downwards and the sunlight detector 9 is turned facing upwards when the drone 3 is in hovering flight.

In the example shown, the body 55 of the drone presents top and bottom surfaces 61, 63 designed to be facing upwards and downwards respectively when the drone 3 is in hovering flight.

The sunlight detector 9 is attached to the top surface 61, preferably directly on the top surface, 61. This orientation is favourable for measuring the ambient light intensity.

The multi-band sensor 5 is attached to the bottom surface, either directly or by means of a clamp such as the clamp 65 shown in FIG. 1.

The multi-band sensor may even be attached at one front end of the body by means of the clamp 65.

According to yet another aspect, the invention relates to a calculation method for calculating the characteristic variable value of the light intensity returned by the target in the plurality of predetermined bands of frequencies.

This method includes the following steps:
flying over the target 8 by making use of a system that includes a flying drone 3 and an imaging assembly 1, mounted on the drone 3;
during the over-flight, measuring by the imaging assembly 1, at a plurality of successive time instants, of the light intensity returned by the target 8 in each of the said predetermined bands of frequencies;
during the over-flight, measuring by the imaging assembly 1, at a plurality of successive time instants, of the ambient light intensity in each of the said predetermined bands of frequencies, and simultaneously, recording of a parameter characterising the orientation of the sunlight detector 9 in relation to the sun S;
calculation of the characteristic variable value of the light intensity that is returned by the target 8 in each predetermined frequency band by using the light intensities returned by the target 8 in the said previously measured predetermined bands of frequencies and the ambient light intensities in the said previously measured predetermined bands of frequencies.

The imaging assembly 1 is advantageously of the type described here above. By way of a variant, it is different.

The light intensity that is returned by the target 8 in each of the said predetermined bands of frequencies is for example measured by making use of the multi-band sensor 5 described here above.

The ambient light intensity in each of the said predetermined bands of frequencies is measured for example by using the sunlight detector 9 described here above.

The calculated characteristic variable value is for example the light intensity returned by the target 8 in the predetermined frequency band corrected as a function of the ambient light intensity measurements, or corresponds to the reflectance of the target 8 in the predetermined frequency band, or is any other pertinent variable value.

For the recording of the parameter that characterises the orientation of the sunlight detector 9 in relation to the sun S, the imaging assembly 1 is equipped with an orientation sensor for determining orientation, for example from an inertial centre, that makes it possible to determine on an ongoing basis the orientation of the detector 9 in relation to a reference direction, the magnetic north for example.

The orientation of the sunlight detector 9 in relation to the sun S is determined for example by first calculating the orientation of the sun in relation to the reference direction at the geographical point and at the time instant at which the measurement is carried out. Then, the orientation of the sunlight detector 9 in relation to the sun S is determined by using the orientation of the detector 9 in relation to a reference direction and the orientation of the sun in relation to the reference direction.

The calculation step includes a calculation sub-step ILT for calculating the total light intensity received by the target 8 in at least one of the frequency bands, based on the ambient light intensity measured in the or each frequency band. This value is for example compared to the one determined directly by the multi-band sensor 5 and makes it possible to correct the value obtained by the multi-band sensor.

In order to do this, the following equation (1) is advantageously used:

E_{sun,eff}=∫_{0→∞}SₛE_{sun,obj}dλ=(I−I₀)/(τₛKₛgₛ)(ε cos β+(1−ε)/(ε cos κ+(1−ε)) (1)

where
E_{sun, eff} is the total light intensity received by the target 8 in the frequency band;
Sₛ is the spectral sensitivity of the sunlight detector for the frequency band;
E_{sun, obj} is the light intensity received by the target 8 in frequency λ;
I is the intensity measured by the sunlight detector for the frequency band;
I₀ is the intensity measured by the sunlight detector for the band in the absence of light;
K_{S} is the gain of the sunlight detector;
τₛ is the time of exposure;
gₛ is the sensitivity of the sunlight detector.
ε is a parameter obtained by the following equation (2):

ε=Ed/(Ed+Es) (2)

where Ed is the direct irradiance and Es is the diffuse irradiance.

The direct irradiance corresponds to the light intensity arriving directly from the sun on to the target. The diffuse irradiance corresponds to the diffuse light intensity, arriving on to the target from all directions.

Thus, here the total light intensity received by the target 8 in the frequency band is understood to refer to the integral of the light intensity received for all the frequencies of the frequency band.

The angles β and κ are represented on FIG. 8. The angle κ typically corresponds to the angle between the direction of the sun S viewed from the sunlight detector 9 and the normal to the sunlight detector 9. The angle β typically corresponds to the angle between the direction of the sun S viewed from the target 8 and the normal to the target 8.

For a horizontal surface, the angle β corresponds to 90°−γ, γ being the altitude of the sun from the point of view of the observer O (see the left side of FIG. 8).

The calculation step includes a determination sub-step DOB for determining the orientation of the target 8 in relation to the sun S. This sub-step is carried out for example by means of image analysis, based on photos of the target 8 taken during the overflight. These photos are taken for example by the RGB camera 15.

This sub-step DOB thus provides the ability to determine the angle β. This value is used in the sub-step ILT, in the equation (1).

The parameter ε is known only with a high margin of error. In order to simplify the calculations by using the equation (1), use is made in the sub-step ILT only of the ambient light intensities in the frequency band measured when a difference between the orientation of the sunlight detector 9 in relation to the sun S and the orientation of the target 8 in relation to the sun S is less than a predetermined value.

In other words, use is made only of the ambient light intensities measured at time instants where the angles β and κ are close to one another. In this case, the term (ε cos β+(1−ε))/(ε cos κ+(1−ε)) of the equation (1) is close to 1, such that E_{sun, eff} is independent of ε.

The predetermined value mentioned here above corresponds for example to a difference between the angles β and κ that is less than 20°, preferably less than 10°, even more preferably less than 2°.

1. An imaging assembly for a drone, the assembly including:
a multi-band sensor, comprising a plurality of light sensors each for measuring a light intensity returned by a target in a predetermined frequency band, the bands of frequencies associated with the various different light sensors being different from each other;
a sunlight detector, comprising a plurality of control sensors each for measuring an ambient light intensity in one of the predetermined bands of frequencies of the multi-band sensor, with the sunlight detector including for each control sensor a band-pass filtre configured so as to ensure that an incident ray of light within the associated frequency band arrives at a photosensitive surface of the said control sensor and that an incident ray of light outside the associated frequency band does not arrive at a photosensitive surface of the said control sensor;
an electronic module configured so as to calculate at least one characteristic variable value of the light intensity returned by the target in each predetermined frequency band, by using the light intensities returned by the target in the said predetermined bands of frequencies measured by the multi-band sensor and the ambient light intensities in the said predetermined bands of frequencies measured by the sunlight detector;
the sunlight detector comprising a box casing, the control sensors being attached to the box casing, the band-pass filtres being attached to the box casing each one so as to be facing the photosensitive surface of the associated control sensor.

2. An assembly according to claim 1, wherein the multi-band sensor includes another box casing that is independent and separate from the box casing of the sunlight detector, the light sensors being attached to the said other box casing.

3. An assembly according to claim 1, wherein the sunlight sensor includes a light diffuser, attached to the box casing so as to be facing the band-pass filtres, in a manner such that the incident light rays pass through the light diffuser before reaching the band-pass filtres.

4. An assembly according to claim 3, wherein the sunlight detector includes, for each control sensor, a convergent lens disposed so as to be facing the corresponding band-pass filtre and interposed between the light diffuser and the said band-pass filtre.

5. An assembly according to claim 3, wherein the sunlight detector includes a single convergent lens disposed so as to be facing all of the band-pass filtres and interposed between the light diffuser and the said band-pass filtres.

6. An assembly according to claim 3, wherein the sunlight detector includes, for each control sensor, a screen disposed so as to be facing the associated band-pass filtre and interposed between the light diffuser and the said band-pass filtre, the screen having a conical aperture converging from the diffuser towards the said band-pass filtre.

7. An assembly according to claim 1, wherein the sunlight detector comprises a plate and a support attached on to the plate and delimiting a plurality of wells, the control sensors being mounted on to the plate each at the bottom of one of the wells, the band-pass filtres being mounted in the wells above the control sensors.

8. A system that includes flying a drone and an imaging assembly according to the claim 1, mounted on the drone.

9. A system according to claim 8, wherein the drone comprises a body having top and bottom surfaces provided so as to be turned upwards and downwards respectively when the drone is in hovering flight, the multi-band sensor being attached to the bottom surface and the sunlight detector being attached to the top surface.

10. A calculation method for calculation of at least one characteristic variable value of the light intensity returned by a target in a plurality of predetermined bands of frequencies, the method including the following steps:
flying over the target by making use of a system that includes a flying drone and an imaging assembly having a sunlight detector;
during the over-flight, measuring by the imaging assembly, at a plurality of successive time instants, of the light intensity returned by the target in each of the said predetermined bands of frequencies;
during the over-flight, measuring by the imaging assembly, at a plurality of successive time instants, of the ambient light intensity in each of the said predetermined bands of frequencies, and simultaneously, recording of a parameter characterising the orientation of the sunlight detector in relation to the sun;
calculation of the characteristic variable value of the light intensity that is returned by the target in each predetermined frequency band by using the light intensities returned by the target (8) in the said previously measured predetermined bands of frequencies and the ambient light intensities in the said previously measured predetermined bands of frequencies;
the calculation step includes:
a determination sub-step for determining the orientation of the target in relation to the sun;
a calculation sub-step for calculating the total light intensity received by the target in at least one of the frequency bands, using only the ambient light intensities in the said frequency band that are measured when a difference between the orientation of the sunlight detector in relation to the sun and the orientation of the target in relation to the sun is less than a predetermined value.
